(19) United States
(12) Patent Application Publication
(10) Pub. No.: US 2013/0024231 A1
(43) Pub. Date: Jan. 24, 2013

(54) Project Task Management

(71) Applicants: Candace Gordon, Jacksonville, FL (US); Todd Lowney, Jacksonville, FL (US); Keith Roach, Jacksonville, FL (US)

(72) Inventors: Candace Gordon, Jacksonville, FL (US); Todd Lowney, Jacksonville, FL (US); Keith Roach, Jacksonville, FL (US)

(73) Assignee: Bank of America Corporation, Charlotte, NC (US)

(21) Appl. No.: 13/186,632

(22) Filed: Jul. 20, 2011

(51) Int. Cl. G06Q 10/00

(52) U.S. Cl. 705/7.17; 705/7.12

(57) ABSTRACT

Systems, methods, apparatuses, and computer readable media associated with identifying tasks associated with a project and automatically assigning those tasks are provided. In some examples, the systems, methods, and the like may include receiving a project and identifying a project type. The systems, methods, and the like may further include identifying a plurality of tasks associated with the project based on the identified project type. The identified tasks may be matched to one or more roles associated with the project and automatically assigned to individuals associated with the roles. In some examples, the systems, methods, and the like provided herein may include storing data associated with tasks, projects, and the like. The historical data may be trended to aid in predictive analysis and determining staffing needs, and the like.

### BACKGROUND

Efficient project management is an important aspect of many businesses. Efficient project management includes not only having people with the necessary skill set to perform the work, but also having a sufficient number of people. Often, businesses are reactionary and thus, ramp up staffing after projects have already come in. This may leave the business behind before the project has even begun and may lead to short cuts, etc. that may result in inferior work or delays.

Further, many conventional project management systems require identification of tasks associated with a project once the project is received. This may be time consuming and inefficient. In addition, many conventional systems provide little organization of duties and minimal oversight of the individuals completing tasks within the project. Accordingly, a project task management system with efficient identification of tasks, task tracking, and tracking of historical data would be advantageous.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, systems, devices, computer readable media and methods for identifying tasks associated with a project and automatically assigning those tasks are provided. In some examples, the systems and methods may include receiving a project and identifying a project type. The systems and methods may further include identifying a plurality of tasks associated with the project based on the identified project type. The systems and methods may further include matching the identified tasks to one or more roles associated with the project and automatically assigning the tasks to individuals associated with the roles.

Still other aspects of the systems and methods provided herein include storing data associated with tasks, projects, etc. The historical data may be trended to aid in predictive analysis and determining staffing needs, etc.

### BRIEF DESCRIPTION OF THE DRAWINGS

The present disclosure is illustrated by way of example and not limited in the accompanying figures in which like reference numerals indicate similar elements.

FIG. 1 illustrates an example operating environment in which various aspects of the disclosure may be implemented.

FIG. 2 illustrates an example system for receiving projects, identifying tasks and automatically assigning tasks according to one or more aspects described herein.

FIG. 3 illustrates one example method of receiving projects, identifying tasks and automatically assigning tasks according to one or more aspects described herein.

FIG. 4 illustrates one example user interface for displaying one or more tasks associated with a user according to one or more aspects described herein.

FIG. 5 illustrates one example user interface displaying one or more tasks associated with the project according to one or more aspects described herein.

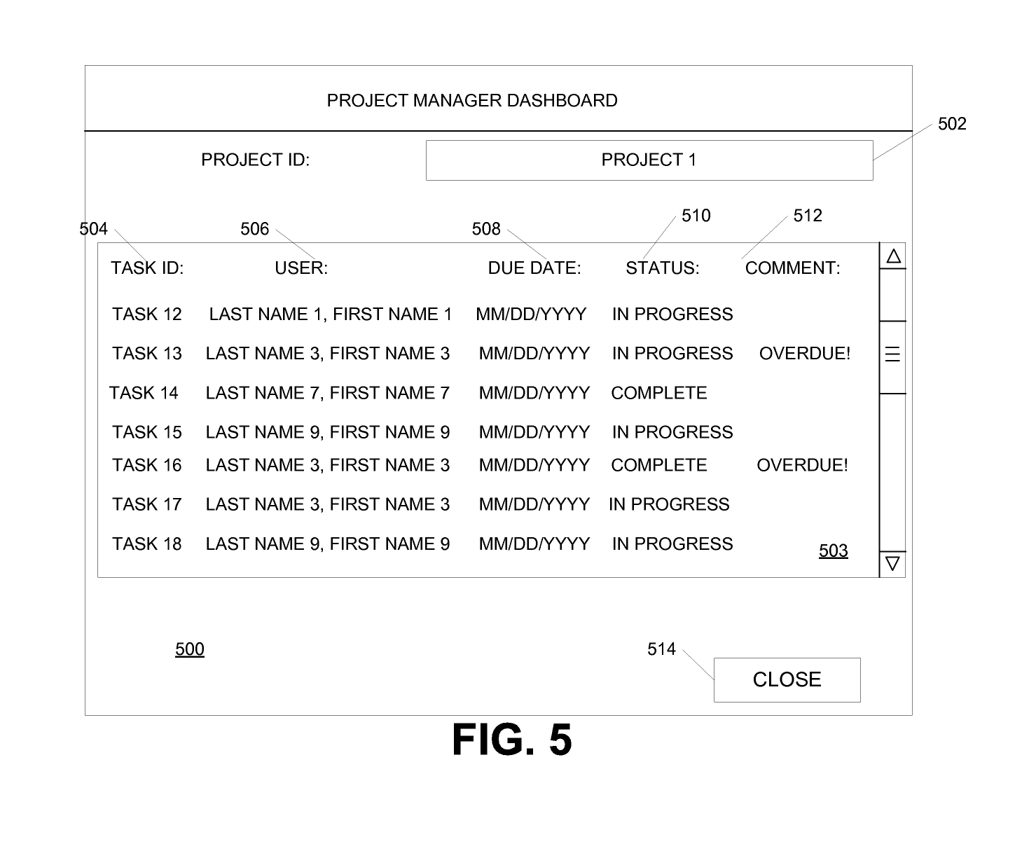

FIG. 6 illustrates one example chart displaying historical project and/or task data according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

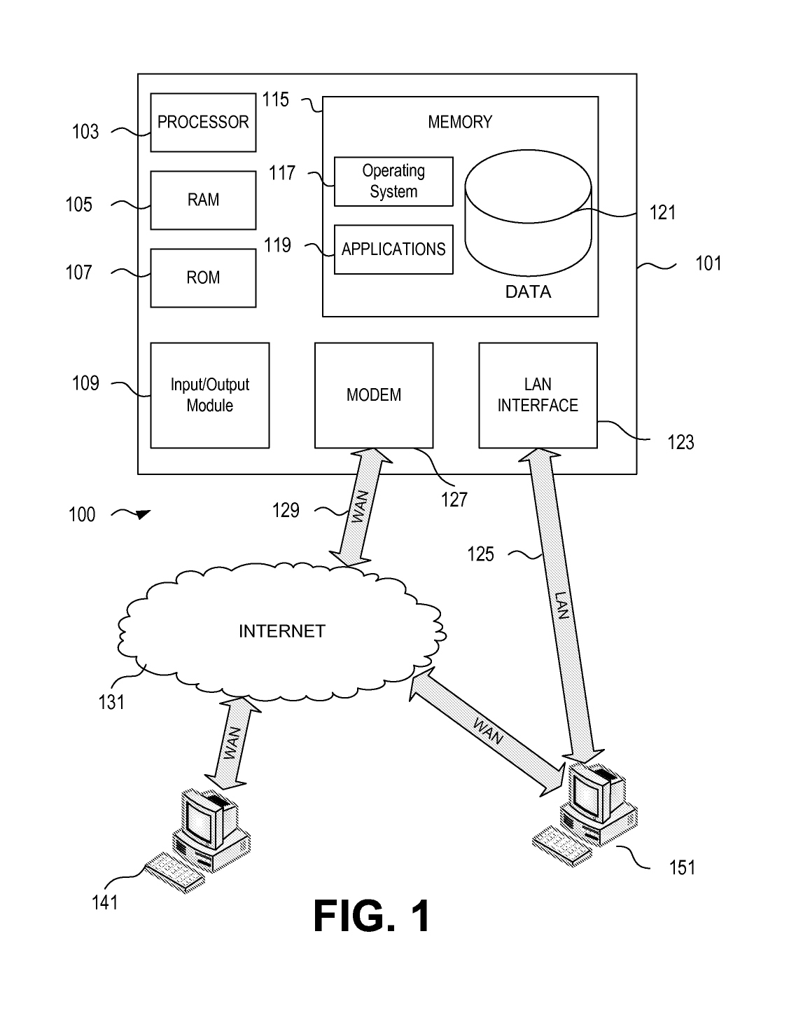

FIG. 1 illustrates a block diagram of a generic computing device 101 (e.g., a computer server) in computing environment 100 that may be used according to an illustrative embodiment of the disclosure. The computing device 101 may have a processor 103 for controlling overall operation of the device and its associated components, including random access memory (RAM) 105, read-only memory (ROM) 107, input/output (I/O) module 109, and memory 115.

I/O 109 may include a microphone, mouse, keypad, touch screen, scanner, optical reader, and/or stylus (or other input device(s)) through which a user of server 101 may provide input, and may also include one or more of a speaker for providing audio output and a video display device for providing textual, audiovisual and/or graphical output. Software may be stored within memory 115 and/or other storage to provide instructions to processor 103 for enabling server 101 to perform various functions. For example, memory 115 may store software used by the server 101, such as an operating system 117, application programs 119, and an associated database 121. Alternatively, some or all of server 101 computer executable instructions may be embodied in hardware or firmware (not shown).

The computing device 101 may operate in a networked environment supporting connections to one or more remote computers, such as terminals 141 and 151. The terminals 141 and 151 may be personal computers or servers that include many or all of the elements described above relative to the server 101. The network connections depicted in FIG. 1 include a local area network (LAN) 125 and a wide area network (WAN) 129, but may also include other networks. When used in a LAN networking environment, the server 101 may be connected to the LAN 125 through a network interface or adapter 123. When used in a WAN networking environment, the server 101 may include a modem 127 or other network interface for establishing communications over the WAN 129, such as the Internet 131. It will be appreciated that the network connections shown are illustrative and other means of establishing a communications link between the computers may be used. The existence of any of various well-known protocols such as TCP/IP, Ethernet, FTP, HTTP, HTTPS, and the like is presumed.

Computing device 101 and/or terminals 141 or 151 may also be mobile terminals (e.g., mobile phones, PDAs, notebooks, etc.) including various other components, such as a battery, speaker, and antennas (not shown).

The disclosure is operational with numerous other general purpose or special purpose computing system environments or configurations. Examples of well known computing systems, environments, and/or configurations that may be suitable for use with the disclosure include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The disclosure may be described in the general context of computer-executable instructions, such as program modules, being executed by one or more computers and/or one or more processors associated with the computers. Generally, program modules include routines, programs, objects, components, data structures, etc. that perform particular tasks or implement particular abstract data types. Aspects of the disclosure may also be practiced in distributed computing environments where tasks are performed by remote processing devices that are linked through a communications network. In a distributed computing environment, program modules may be located in both local and remote computer storage media including memory storage devices.

The above-described systems may be used in various businesses or corporate entities, such as financial institutions or other entities, to aid in managing one or more projects, tasks associated with projects, and the like. For example, the systems, methods, apparatuses, and computer-readable media described herein may include receiving a project and identifying a plurality of pre-defined tasks associated with the project based on project type, characteristics of the project, etc. The identified tasks may be assigned to users based on a role assigned to the user. The users may then complete the tasks and a project manager or other administrator may observe progress for one or more tasks from a user interface.

Additionally or alternatively, the systems, methods, apparatuses, and computer-readable media described herein may be used to maintain historical records of projects, project tasks, etc. to provide predictive analysis which may be useful for determining staffing needs. For instance, administrators may track when (e.g., what time of year, month, etc.) an influx of projects is generally received and may plan to increase staffing for that time period in advance. Additional details, examples, etc. are provided below. Further, although several examples used herein may include reference to a financial institution or projects associated with the financial institution, the systems and methods described herein may be used in a variety of industries (e.g., service and non-service industries), corporations, businesses, government agencies, universities, other types of organizations and the like. Nothing in the specification or figures should be viewed as limiting the invention to only use with banking or financial services related entities.

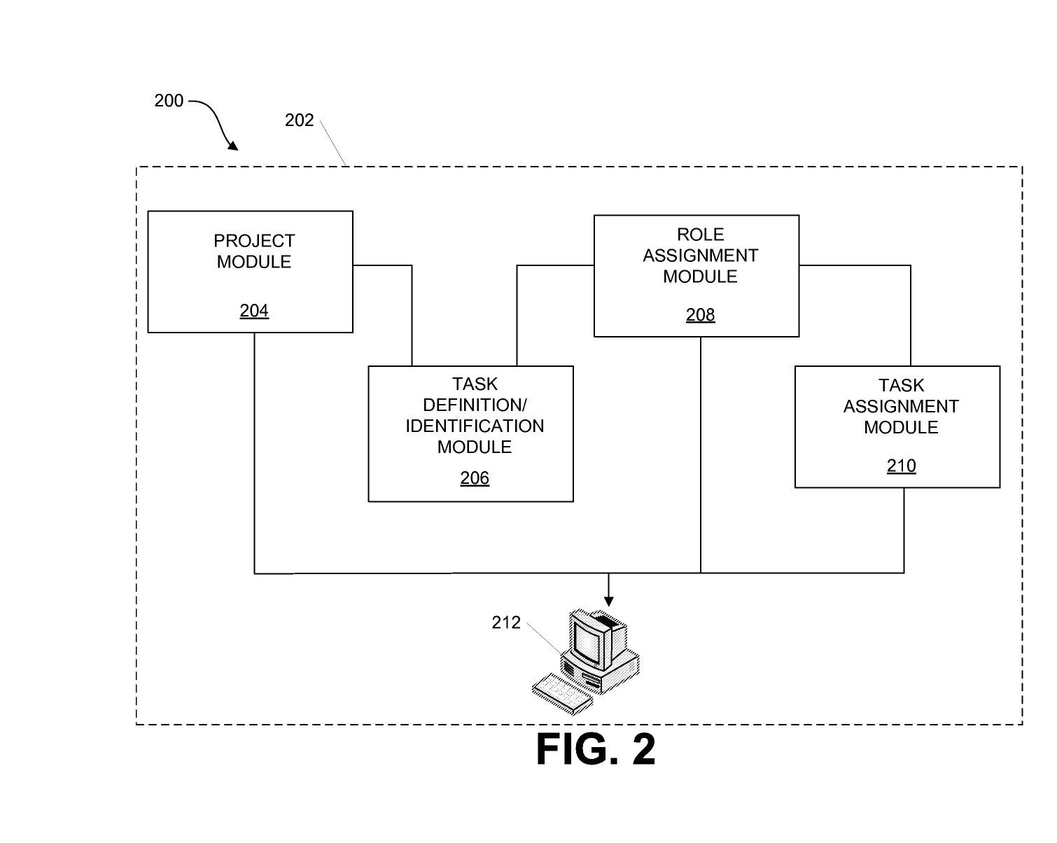

FIG. 2 illustrates one example project task system for receiving projects, identifying tasks associated with the project, and assigning those tasks according to at least some examples described herein. The project task system 200 may be part of or associated with an entity 202, such as the entity implementing the system. The entity 202 may be a business, corporation, university or other educational institution, government agency, and the like. In some examples, the entity may be a financial institution, such as a bank. For simplicity, the project task system 200 will be described in terms of a financial institution. However, nothing in the specification or figures should be viewed as limiting any of the features or aspects described herein to only banks or banking related issues. In some examples, the project task system may be external to or separate from the entity 202 (e.g., provided by or associated with a 3^{rd} party or outside vendor).

In some examples, the project task system 200 may be accessed via a network, such as the Internet. Additionally or alternatively, the project task system 200 may be accessed by systems internal to the entity 202, such as an intranet.

The project task system 200 may include a project module 204. The project module 204 may receive one or more projects or project specifications. In some examples, the project information may be input into the project module 204 via user input from computing device 212. Computing device 212 may include one or more computers (e.g., desktop computers, laptop computers, netbooks, computing terminals, etc.) such as computer 100 of FIG. 1, cell phone, smart phone, and the like. Additionally or alternatively, the project and/or project information may be received at the project module 204 via an automated system in which defined projects are forwarded to the project task system 200 and are received at the project module 204.

In some examples, the project module 204 may identify a type of project received. For instance, based on the received project and/or project information, the project module 204 may associate a type of project with that project. The project type may aid in identifying one or more pre-defined tasks associated with the project. The project information may also include the type of platform being used (e.g., Mainframe, Informatica, IIS Data State, Teradata, and the like), management or business group associated with the project, type of technology associated with the project, etc.

The project task system 200 may also include a task definition/identification module 206. In some examples, as a project is received, one or more tasks associated with the project may be defined. Some example tasks may include, for example, project document reviews, Operational Support Manual reviews, Service Level Agreement preparation, reviews and approvals, and the like. In some arrangements, the tasks may be defined by an administrator, such as a project manager and may be associated with the project or project type.

In some examples, the tasks may be defined initially, such as at an initial, one-time set up. That is, tasks may be defined the first time a project or project type is received. Any subsequent projects that are similar or of the same project type may then have tasks automatically identified for the subsequent project based on the pre-defined tasks. In some examples, the definition of tasks for all project types may be done all together, at one time, for instance, upon implementation of the project task system 200. Additionally or alternatively, tasks may be defined for each project type as the project is received. However, regardless of how the tasks are defined, the tasks will be stored and may be available for identification for subsequent projects.

The project task system 200 may further include a role assignment module 208. In some arrangements, a project may have a plurality of roles associated with the project or project type. Some example roles may include analyst, project manager, etc. The role assignment module 208 may store data matching one or more roles to one or more tasks, such as the tasks defined or identified in the task module 206. For instance, when the project is received and the tasks associated with the project identified, the role assignment module 208 may match the identified tasks to one or more identified roles. The tasks may then automatically be assigned to one or more users having the assigned role, such as by the task assignment module 210.

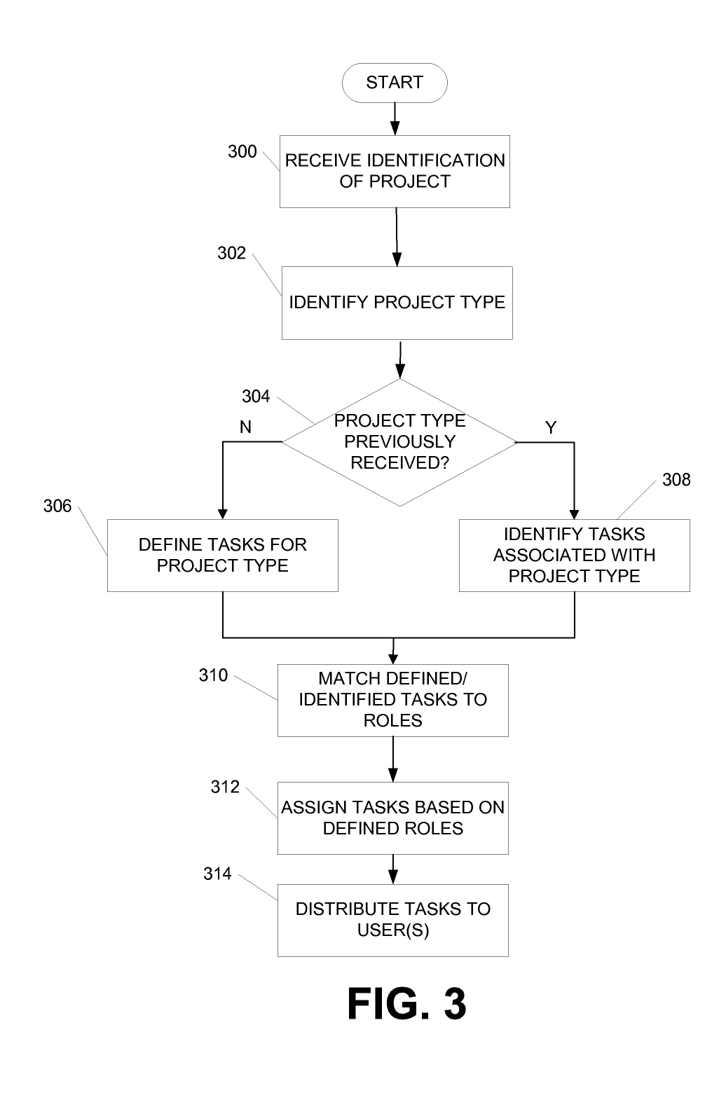

FIG. 3 illustrates one example method of receiving a project and assigning tasks according to one or more aspects described herein. In step 300, a project is received. Receipt of the project may include project data, characteristics or features of the project, due dates for the project, etc. In step 302, a project type is identified. The type of project may be determined from a predefined list of project types, in some examples. In other examples, the project type may be determined from user input received by, for instance, a project module (e.g., 204 in FIG. 2).

In step 304, a determination is made as to whether a project of the identified type in step 302 has been previously received. If not, one or more tasks associated with the project may be defined in step 306. The tasks defined may include those to complete the entire project or a portion thereof. For instance, the defined tasks may correspond to every aspect of the project such that completion of all tasks defined for the project type may coincide with completion of the entire project. In other examples, the tasks may correspond to a portion of the project.

If, in step 304, the project is a type which has previously been received, one or more tasks (e.g., predefined tasks) may be identified and associated with the project in step 308. In some examples, the tasks may be automatically associated with the project based on the received project information and/or identified project type. In step 310, defined/identified tasks may be matched to one or more roles associated with completion of the task. As discussed above, a plurality of roles may be identified that identify types of individuals needed or desired to complete one or more tasks (e.g., having the appropriate skill set, experience, etc.). The role(s) may be matched to the defined or identified tasks in order to automatically assign the identified tasks to the particular role(s), as in step 312. Once the tasks have been assigned to the appropriate role(s), the tasks may be distributed to one or more user(s) having the appropriate designated role(s) in step 314.

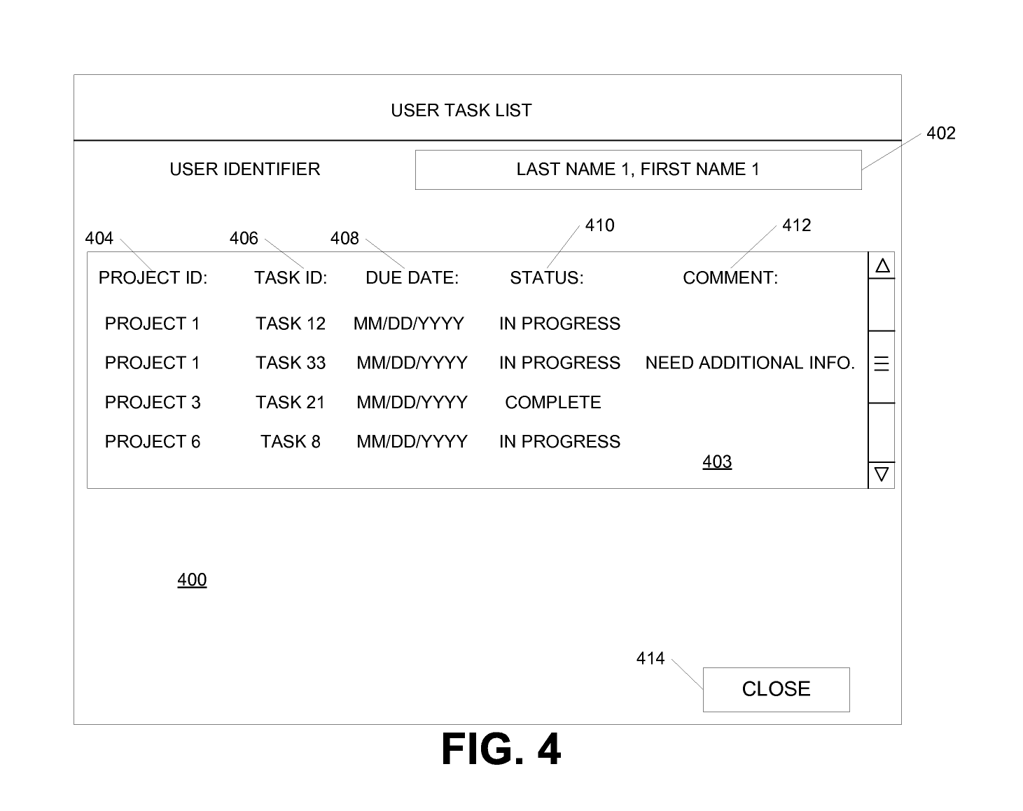

Once tasks are assigned to a user, the tasks may be managed by the user via a user interface, such as user task interface 400 in FIG. 4. The user task interface 400 may provide an overview of the tasks assigned to a particular user and may provide a “big picture” view of the tasks that are expected to be completed by that user. The interface 400 includes a user identifier region 402. The user identifier region 402 may identify the user associated with the tasks being displayed. The user may be identified by name, employee number, or other unique identifier.

The interface 400 further includes task list region 403. The task list region 403 may include some or all tasks assigned to or associated with the user identified in region 402. The task list region may include a project identifier in column 404. The project identifier 404 may identify the project associated with an individual task. The project may be identified by name, number, etc. The task list region further includes a task identifier column 406. The task identifier column 406 includes the tasks assigned to or associated with the user identified in field 402. The tasks may be identified by number, name, etc.

The task list region 403 may further include a due date for each task in column 408. The due date may be automatically generated for each task and may be based on predefined task duration guidelines that identify an approximate length of time to complete the task. The due date may also be based on an overall due date for the project.

The task list region 403 may further include a status column 410. The status column 410 may indicate whether the task is still being worked on (“in progress”) or has been completed (“completed”). In some arrangements, tasks may be filtered to display various tasks. In some examples, a filter may be a pre-defined search against existing data allowing a user to narrow the focus to the desired data. For instance, one or more filter criteria may be used to view tasks in-progress, overdue, completed, and/or all tasks assigned. The filter(s) may be pre-defined to permit controlled flexibility for viewing tasks and meeting a user's viewing needs. Column 412 provides a comment area for each task in which the user may insert additional information, reminders, etc.

The user may select a task from the list to obtain additional information about the task (e.g., via a pop-up interface) or to adjust the settings (e.g., mark complete, add comment, etc.) as desired. Further, a slider may be provided to scroll through additional tasks that may not be visible on the portion of the task list region 403 shown. The user may close out of the interface 400 by selecting “close” option 414.

The tasks associated with a project may also be visible to a project manager or other administrator, such as via dashboard interface 500. The dashboard interface 500 includes a project identifier in field 502. The project identifier field 502 may include the name or other unique identifier associated with the project. The interface 500 may further include project task field 503. The project task field 503 may include a list of tasks associated with the project in column 504. The tasks may be identified by a task identifier that may be a name, number or other unique identifier. Column 506 identifies the user to whom that task is assigned. The user may be identified by name, employee number or other unique identifier. Column 508 indicates the due date for each task and column 510 provides the status of the task. Column 512 is a comment column and may indicate that a task is overdue or on hold or various other comments may be provided. The user (e.g., project manager) may close out of the interface by selecting “close” option 514.

The dashboard interface 500 may permit the project manager or other administrator to obtain an overview of the status of the project and each task. For instance, the dashboard may indicate which tasks or users are overdue, which tasks are being worked on, whether a user is not responding, etc. This may enable the project manager to anticipate issues with tasks, users, deadlines, etc. and take action early on in order to minimize the effect on the rest of the project.

The project task system may include storage of tasks, projects, due dates, etc. This information may be stored and historical trends, etc. may be produced from the data. These historical trends may aid in predictive analysis. For instance, the historical data may aid in identifying times of year, etc. when a higher than usual number of projects is received. For instance, if the historical information indicates that the month of September has brought a substantial increase in projects for the past 4 years, project managers may use that information to increase staffing for the current year as the month of September approaches to be better equipped to deal with the influx of projects. The predictive analysis from historical data may also indicate types of projects that may be coming.

These predictions based on historical data may aid in reducing risk associated with projects. For instance, if the entity is short staffed and an influx of projects is received, corners may be cut in order to meet deadlines, etc. This may result in inferior work product, increased costs down the line, delays etc. However, the predictive analysis associated with this system, method, etc. may reduce or eliminate those risks by aiding the entity in being more prepared for projects.

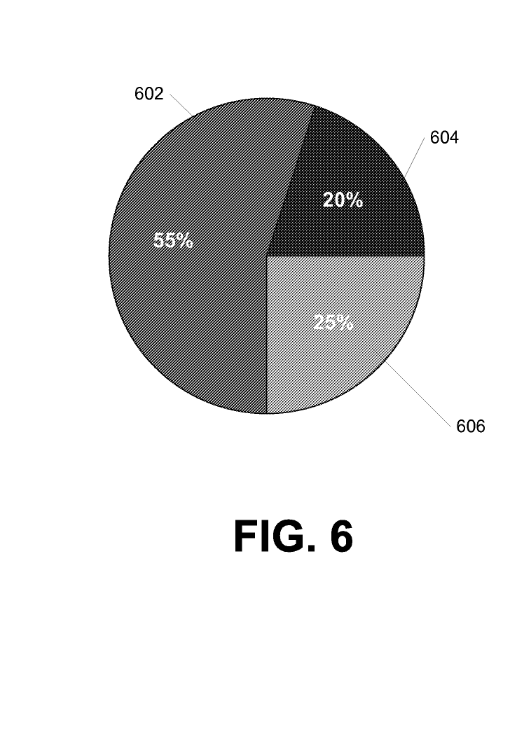

FIG. 6 illustrates one example graph that may be generated from historical data. FIG. 6 is pie chart indicating the types of projects that have come in the first quarter of the past 3 years. For instance, pie slice 602 indicates projects of type 2, while slice 604 indicates projects of type 5 and slice 606 indicates projects of type 9. As shown in the graph, slice 602 is the largest percentage and thus more projects of type 2 have been received in the first quarter of the past three years than the other types of projects. This information may be used to increase staffing in the first quarter of the coming year with people having the skills needed to complete tasks associated with projects of type 2.

Although this is one example graph, various other types of graphs and information may be presented in graphical form from the historical data without departing from the invention.

The project task system and method described herein may further be customizable in order to adapt to various industries or changes. For instance, the types of tasks, etc. may be modified as needed to include additional tasks, remove redundant tasks, etc. In another example, predefined durations for tasks (e.g., for generating automatic due dates) may be revised based on historical data indicating that more or less time may be needed for those tasks.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

1. An apparatus, comprising:
at least one processor; and
memory operatively coupled to the processor and storing computer readable instructions that, when executed, cause the apparatus to:
receive a first project having a first project criterion;
identify a plurality of predefined tasks associated with the first project based on the received first project criterion;
identify a plurality of roles associated with the first project;
assign the plurality of roles associated with the first project to one or more users;
assign a first task of the plurality of tasks to a first identified role of the plurality of roles associated with the first project;
assign the first task of the of tasks a duration based on historical data indicating time needed for the first task of the plurality of tasks; and
display the assigned first task to a user assigned the first identified role.

2. The apparatus of claim 1, wherein the first project criterion includes at least one of: business group, platform and technology area.

3. The apparatus of claim 1, the memory further including instructions that, when executed, cause the processor to display a plurality of tasks assigned to the user, the plurality of tasks including tasks from the first project and at least a second project different from the first project.

4. The apparatus of claim 1, the memory further including instructions that, when executed, cause the processor to:
receive, a second project having a second project criterion;
identify a second plurality of predefined tasks associated with the second project based on the received second project criterion;
identify a plurality of roles associated with the second project;
assign the plurality of roles associated with the second project to one or more users;
assign a first task of the second plurality of tasks to a first identified role of the plurality of roles associated with the second project; and
display the assigned first task of the second plurality of tasks to a user assigned the first identified role of the plurality of roles associated with the second project.

5. The apparatus of claim 1, the memory further including instructions that, when executed, cause the processor to:
assign a second task of the first plurality of tasks to a second identified role of the plurality of roles associated with the first project; and
display the assigned second task to a user assigned the second identified role.

6. The apparatus of claim 5, the memory further including instructions that, when executed, cause the processor to:
display the first task of the first plurality of tasks assigned to the user assigned the first identified role and the second task of the first plurality of tasks assigned to the user assigned the second identified role on a first user interface presented to a project manager.

7. The apparatus of claim 6, wherein displaying the assigned first task to the user assigned the first identified role includes displaying the task on a second user interface different from the first user interface.

8. A method, comprising:
receiving, by a project task system having a processor, a first project having a first project criterion;
identifying a plurality of predefined tasks associated with the first project based on the received first project criterion;
identifying a plurality of roles associated with the first project;
assigning the plurality of roles associated with the first project to one or more users;
assigning a first task of the plurality of tasks to a first identified role of the plurality of roles associated with the first project;
assigning the first task of the plurality of tasks a duration based on historical data indicating time needed for the first task of the plurality of tasks; and
displaying the assigned task to a user assigned the first identified role.

9. The method of claim 8, wherein the first project criterion includes at least one of: business group, platform and technology area.

10. The method of claim 8, further including displaying a plurality of tasks assigned to the user, the plurality of tasks including tasks from the first project and at least a second project different from the first project.

11. The method of claim 8, further including:
assigning a second task of the plurality of tasks to a second identified role of the plurality of roles associated with the first project; and
displaying the second assigned task to a user assigned the second identified role.

12. The method of claim 11, further including:
displaying the first task assigned to the user assigned the first identified role and the second task assigned to the user assigned the second identified role on a first user interface presented to a project manager.

13. The method of claim 12, wherein displaying the first assigned task to the user assigned the first identified role includes displaying the task on a second user interface different from the first user interface.

14. One or more non-transitory computer readable media storing computer readable instructions that, when executed, cause a project task system of a financial institution to:
receive a first project having a first project criterion;
identify a plurality of predefined tasks associated with the first project based on the received first project criterion;
identify a plurality of roles associated with the first project;
assign the plurality of roles associated with the first project to one or more users;
assign a first task of the plurality of tasks to a first identified role of the plurality of roles associated with the first project;
assign the first task of the plurality of tasks a duration based on historical data indicating time needed for the first task of the plurality of tasks; and
display the first assigned task to a user assigned the first identified role.

15. The one or more computer readable media of claim 14, further including instructions that, when executed, cause the processor to display a plurality of tasks assigned to the user, the plurality of tasks including tasks from the first project and at least a second project different from the first project.

16. The one or more computer readable media of claim 14, further including instructions that, when executed, cause the processor to:
assign a second task of the plurality of tasks to a second identified role of the plurality of roles associated with the first project; and
display the second assigned task to a user assigned the second identified role.

17. The one or more computer readable media of claim 16, further including instructions that, when executed, cause the processor to:
display the first task assigned to the user assigned the first identified role and the second task assigned to the user assigned the second identified role on a first user interface presented to a project manager.

18. The one or more computer readable media of claim 17, wherein displaying the first assigned task to the user assigned the first identified role includes displaying the task on a second user interface different from the first user interface.

19. A method, comprising:
receiving, by a project task system, a first project including first project information;
identifying, by a computer processor of the project task system, a first project type associated with the first project;
determining, by the project task system, whether a previous project of the first project type was received prior to receiving the first project;
responsive to determining that the previous project was received:
identifying a plurality of predefined tasks associated with the first project type;
identifying a plurality of roles associated with the first project;
assigning the plurality of tasks to one or more identified roles associated with the first project; and
assigning at least one of the of tasks a duration based on data indicating time needed for the at least one of the plurality of tasks;
responsive to determining that the previous project was not received:
defining a plurality of tasks associated with the first project type;
identifying a plurality of roles associated with the first project; assigning the plurality of tasks to one or more identified roles associated with the first project; and
assigning at least one of the plurality of tasks a duration based on historical data indicating time needed for the at least one of the plurality of tasks.

20. The method of claim 19, further including distributing the assigned plurality of tasks to one or more users associated with each of the one or more identified roles.
